(19) United States
(12) Patent Application Publication
(10) Pub. No.: US 2023/0362016 A1
(43) Pub. Date: Nov. 9, 2023

(54) SECURE APPLICATION COMPUTING ENVIRONMENT IN A FEDERATED EDGE CLOUD

(71) Applicant: Intel Corporation, Santa Clara, CA (US)

(72) Inventors: Dario Sabella, Gassino (IT); Anurag Ranjan, Reading (GB); Neal Oliver, Portland, OR (US); Yevgeniy Yarmosh, Portland, OR (US)

(21) Appl. No.: 18/223,887

(22) Filed: Jul. 19, 2023

(51) Int. Cl. H04L 9/32

(52) U.S. Cl. CPC H04L 9/3263; H04L 9/3247

(57) ABSTRACT

Systems and methods for a secure application computing environment in a federated Edge Cloud are disclosed herein. Application information corresponding to an application from an application provider may be received in a secure environment of a device such as an edge computing node. A trust level for execution of the application may be associated based at least in part on the application information, and based on the associated trust level, a trusted platform may be selected to deploy or launch the application.

### BACKGROUND

Edge computing or the Edge Cloud is computing that takes place at or near the physical location of a user or a source of data. Thus, the computing resources are located at the “edge” of a communications network close to where the network traffic originates. The Edge Cloud is divided and managed by independent entities known as Communication Service Providers (CoSPs). An Operator Platform (OP) is a component that manages an Edge Cloud. The OP is used by an Application Provider to deploy and manage edge applications and is used by a user-client (e.g., a phone, a tablet, or other similar user equipment or user device) to discover and interact with the edge application.

Deploying applications at the Edge Cloud in geographic proximity to the end user improves response time of the application and reduces costs. In real-world use, the end user moves across different geographic areas and as a result, can be connected to different operator platforms. Thus, the environment is natively multi-operator and multi-vendor, and in order to benefit from the application deployment at the Edge Cloud, the application and user data “follows” the end user and deploys at different operator platforms.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an example of an operator platform on a client device to manage an edge application.

FIGS. 2A-2C illustrate variants of a trust status broker in operator platform architecture.

FIG. 3 illustrates example operations for launching an edge application in a secure environment of a partner operator platform.

FIG. 4A illustrates an example flow diagram for trusted deployment of an edge application on a trusted operator platform.

FIG. 4B illustrates an example flow diagram for trusted deployment of an edge application on a trusted operator platform including a hardware-based Trusted Execution Environment (TEE).

FIG. 5 illustrates an example method for launching an edge application in a secure environment of a partner operator platform.

FIG. 6 is a block diagram of an example of a machine upon which any one or more of the techniques (e.g., methodologies) discussed herein can perform.

### DETAILED DESCRIPTION

A federated network is a network model in which a number of separate networks or locations share resources (such as network services and gateways) via a central management framework that enforces consistent configurations and policies. A security issue may arise from federating operator platforms. Specifically, determining what extensions to the functionality of the operator platform are required so that an edge application will be deployed only in a secure environment. Thus, as the network services or data (or an application) connects to different operator platforms, there is a need for mechanisms that transparently move the application and metadata from one operator platform to another, establish trust with the platform that executes the application, and enforce the Application Provider (“App Provider”) and/or end-user defined policies.

A content delivery network (e.g., an Edge Cloud, cloud cache, doghouse, or the like) is a collection of resources over the span of an edge network. A micro data center (e.g., a cloudlet) includes cloud resources, network resources, charging or billing resources, and an Operator Platform (OP). Cloudlets may be located in multiple locations and deemed to all be members of the same Edge Cloud. The OP is a component that manages the Edge Cloud and is used by an App Provider to deploy and manage edge applications. The components or resources of the Cloudlets, the App Provider, and the Operator Platforms interact through a series of reference points or interfaces, including a Northbound Interface (NBI) connecting the App Provider to a main operator platform, an East-West Bound Interface (EWBI) connecting the main OP to additional or secondary OPs, a Southbound Interface (SBI) connecting the main or lead OP to network resources, cloud resources, a charging or billing resource or engine, or the like, and a User Network Interface (UNI) connecting the main OP to a user-client.

An OP may be owned by an individual operator, such as a communications service provider (e.g., a phone company), and an OP may support multiple tenants, or entities that share computing resources. Thus, an important aspect of the functionality of an OP is that it federates with other OPs to provide Edge Cloud services over a wide geographic range, and to a wide range of subscribers of different operators. Federation of edge services provides a security problem and as such, OPs require functionality to ensure that an edge application is deployed only in a secure, trusted environment.

For a single Edge Cloud or a single OP, an App Provider may deploy the edge application by providing application information, such as an application image and application metadata to the OP. The application metadata may describe various system requirements for the edge application including compute requirements, network, storage, and/or accelerator resources (such as Graphics Processing Unit (GPU) resources) required to run the edge application. The Metadata may also include requirements for the geographic location in which the edge application must be located, Quality of Service (QoS) constraints of the edge application that must be satisfied, and/or policies on what users are authorized to use the edge application.

Such a deployment or interaction between the App Provider and the OP may be performed using the NBI discussed above. The OP may then attempt to deploy the edge application so as to satisfy the metadata, however, the App Provider does not have detailed control over the deployment. For example, the App Provider may be assured by the OP that the edge application is running in an appropriate availability zone or region and/or may receive telemetry data from the OP that measures latency and throughput. However, the App Provider may not receive identifying details of the servers on which the edge application runs. When the edge application has special security requirements, such as a strong protection from external attacks or attacks by other Edge Cloud tenants, it is desirable to provide a secure platform for execution of the edge application.

A benefit of deploying an application at an Edge Cloud is that a close geographic proximity to the end user improves response time, reduces costs, etc. As an end user moves across different geographic areas or locations, the user may be connected to different OPs. As a consequence, the OP and the application environment is natively multi-operator and multi-vendor. To benefit from deployment of the application at the Edge Cloud, the application must “follow” the end user and be able to automatically deploy at different operator platforms.

A new functional block in Multi-Access Edge Computing (MEC) architecture called a “Trust Status Broker” (TSB), is a secure environment that may facilitate security verifications for security requirements of the App Provider. The TSB may be included as a part of a Federation Manager and/or a Federation Broker on an OP. Additionally, or alternatively, the TSB or may be a separate entity or separate architecture within a MEC Federator (as discussed below).

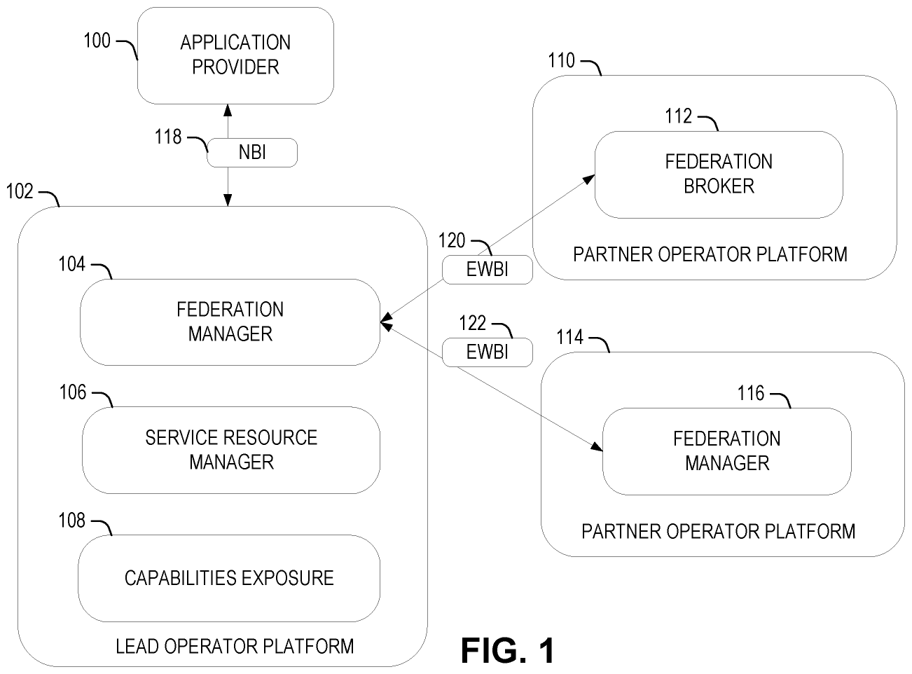

FIG. 1 illustrates an example of an operator platform on a client device to manage an edge application. In FIG. 1, an application provider 100 may provide application information (e.g., application metadata) to a lead operator platform 102 through an NBI 118. The lead operator platform 102 may be a functional block or architecture included on a user device such as a smartphone, a tablet, an in-car entertainment or navigation system of a vehicle, or the like. The lead operator platform 102 may include other architecture that may allow the lead operator platform 102 to perform different functions or take on different roles. For example the lead operator platform 102 may operate in a federation manager 104 role, a service resource manager 106 role, or a capabilities exposure 108 role.

For a federation of operator platforms such as illustrated in FIG. 1, an edge application may be deployed on different operator platforms besides, separate, or apart from the lead operator platform 102 (the operator platform directly connected to the application provider 100). For example, the edge application may be deployed on partner operator platforms in the federation, such as a first partner operator platform 110 and a second partner operator platform 114.

As a federation manager 104, the lead operator platform 102 may implement one or more flows that provision cloud and network resources across operator platforms. For example, in the federation manager 104 role, the lead operator platform 102 may provision the edge application and migrate the edge application to the first partner operator platform 110 and/or the second partner operator platform 114 (collectively “partner operator platforms”). The partner operator platforms 110, 114, may be operator platforms operating on separate or different devices or nodes. The first partner operator platform 110 may further include a federation broker 112, which may work with the federation manager 104 on the lead operator platform 102 and/or a second federation manager 116 located on the second partner operator platform 114, to federate the edge application services across multiple operator platforms.

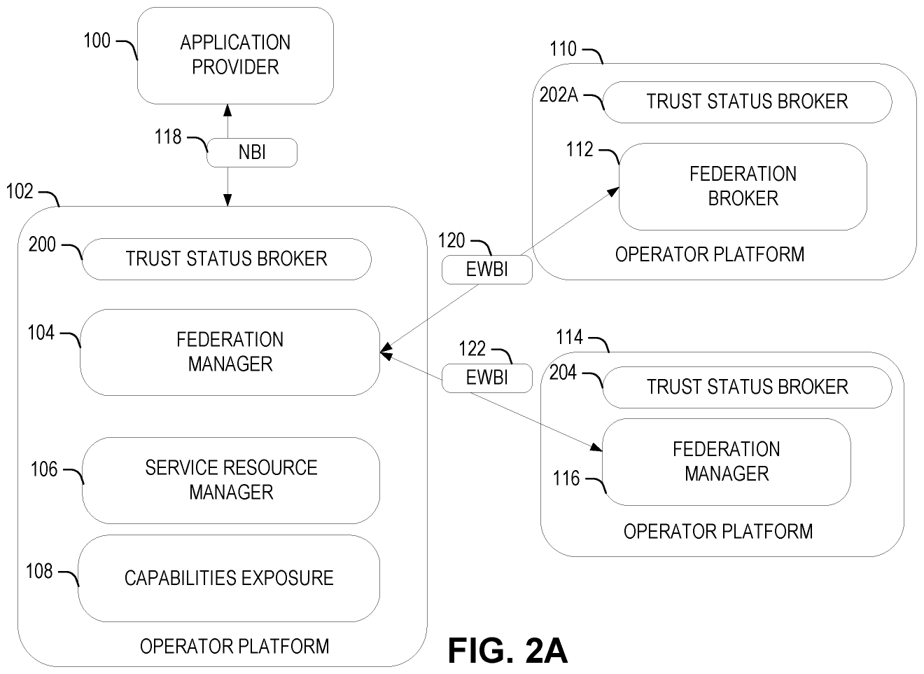

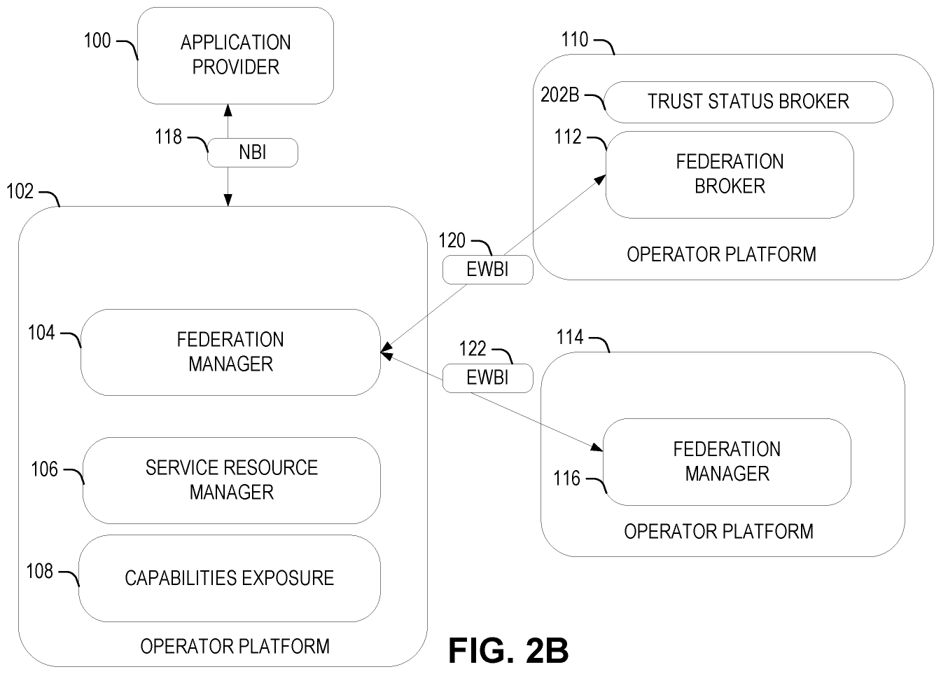

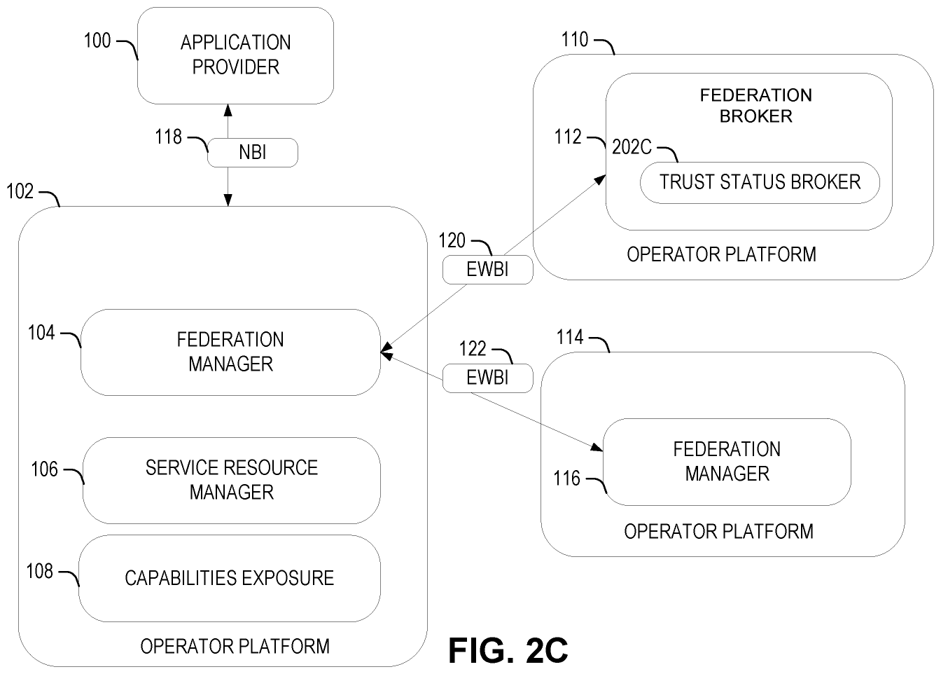

Flows from the lead operator platform 102 to the partner operator platforms 110, 114 may occur over one or more EWBIs, such as a first EWBI 120 and a second EWBI 122. Thus, federated operator platforms interact with each other via the EWBIs, but the application provider 100 does not interact directly with the partner operator platforms 110, 114. As such, the application provider 100 must rely on the lead operator platform 102 to negotiate deployment and migration on behalf of the application provider 100. Therefore, as discussed below for FIGS. 2A-2C, a functional block, representing a new role in the OP architecture called a “trust status broker” (TSB) may be included in one or more of the OPs. The TSB may act as a proxy for the application provider 100 for provisioning the trusted platform resources and deploying the edge application.

FIGS. 2A-2C illustrate variants of a trust status broker in operator platform architecture. As illustrated in FIG. 2A, TSBs may be included as a secure environment on each of the operator platforms. For example, a first TSB 200 may be included on the lead operator platform 102, a second TSB 202A may be included on the first partner operator platform 110, and a third TSB 204 may be included on the second partner operator platform 114. Thus, in the example illustrated in FIG. 2A, each operator platform may include a TSB as a secure environment, secure architecture, or the like.

In the example illustrated in FIG. 2B, TSB 202B, may be included only on the second partner operator platform 110 which operates or includes the federation broker 112. In the example illustrated in FIG. 2C, the TSB 202C may be included as functionality or a component implemented within the federation broker 112.

In each of the examples illustrated in FIGS. 2A-2C, the application provider 100 and the lead operator platform 102 may authenticate each other and establish a secure tunnel or channel (e.g., via the NBI 118) for message exchange. Furthermore, in each example illustrated in FIGS. 2A-2C, the lead operator platform 102 and the application provider 100 may create appropriate keys for application image and application metadata management. The metadata may include a description of the types, levels, or degrees of trust required by the edge application for a platform or operating environment in which the edge application is to be launched. In some examples, one or more operator platforms may provide trusted execution of the edge application, but not a trusted platform (e.g., when appropriate hardware support has not been deployed on all partner operator platforms). In such examples, the granularity of trusted platform capability that the application provider 100 may negotiate may include at least a trusted platform and a trusted application.

In the example illustrated in FIG. 2A, when each operator platform includes a TSB, for each occurrence with two operator platforms federating with each other, the TSBs, first TSB 200 second TSB 202A, and third TSB 204, may authenticate with each other and set up secure tunnels for message and/or data exchange. The TSBs may form a mesh topology. Alternatively, one of the TSBs (e.g., first TSB 200) may be designated as a primary TSB. The primary TSB may broker authentications for all other individual TSBs. Any of the TSBs may be architecture of the operator platforms or may be a computing resource separate from the operator platforms and secured via secure tunnels and physical security of the OP (the security of the physical infrastructure elements such as a MEC platform, an MEC Orchestrator, a MEC Federator, or the like). The method by which TSBs discover and authenticate with each other may be OP dependent and the OPs may utilize operation support systems and/or orchestrators to implement these functions. Additionally, an individual OP or a federation of OPs may provide a Root of Trust (RoT) which may be used as a part of the discovery process and/or the authentication process.

The flow of the application information and data across the OPs may require maintenance of various state information in order to be trusted. Thus, the TSBs must maintain these information elements and support flows between the TSB and other components of the operator platforms to secure them. Information elements may include one or more of: an identifier of cloud and/or network resources, metadata of an edge application to be secured, and/or an IP address or identifier of user equipment and/or the edge application. The example of FIG. 2A in which a TSB is included on each of the lead operator platform 102, the first partner operator platform 110, and the second partner operator platform 114 may be a general case in which a TSB is always present in every operator platform and acting at the NBI and EWBI sides.

A potential advantage to using TSBs on the operator platforms includes that, the application provider 100, rather than requiring the application to run only on the lead operator platform 102, may allow the application to be deployed or migrated to the partner operator platforms (e.g., to other devices connected to or available to be network-connected to the lead operator platform 102). This allows the application provider 100 to provide a better user experience to users of the application while still meeting the trust requirements and/or other QoS requirements of the application provider 100.

In an example, the underlying architecture or platform for a TSB, or for a cloud resource on which the edge application executes, may utilize or include one or more of the following approaches:
1. A Trusted Execution Environment (TEE), or a similar secure area within a processor that runs an isolated environment parallel to the main operating system. Through this isolation (which may be a hardware-based isolation), the TEE may help ensure that code and data uploaded into it cannot be tampered with by malicious actors and/or the operator of a physical node or device.
2. Confidential Computing (CC) or a privacy preserving computational principle that leverages hardware-based TEEs for protecting any data being processed.
3. TEE Attestation, which is a process of presenting evidence by a TEE to another party called a verifier. The verifier may be another TEE (e.g., a separate TEE running on another device) or may be a non-TEE component. In an example, the TEEs of the partner and lead TSBs may mutually authenticate or otherwise perform mutual attestation, and a TEE of the edge application and the application provider 100 backend may employ one-way attestation. Attestation between the TEE of partner TSBs and the TEE of the edge application may be one way (e.g., the TSB verifies the edge application) or mutual. Attestation of the TEEs may be complimented by other authentication methods (e.g., Mutual Transport Layer Security (m-TLS), or the like).
4. Computational Trust established via TEE attestation (e.g., between the TEEs of two different TSBs as discussed above).
5. Institutional Trust established by the operator platforms when they join the federation. Institutional trust may be established by an exchange of credentials that may be used by the partner and lead TSBs for mutual authentication.
6. Trusted Placement of the Edge Application. Trusted placement is a mechanism that may allow for deployment of the edge application at the partner operator platform and may help ensure end-to-end, the integrity of the application data, data confidentiality, code integrity, code confidentiality, user privacy, or the like. Thus, the application provider 100 does not have to connect, or otherwise establish relations with the partner operator platforms 110, 114 to deploy the edge application.
7. Edge Application Integrity, which may be enforced by the partner and lead TSBs based on a binary signing and/or hash calculation of the edge application. The integrity of the edge application metadata may be ensured because the metadata may be kept within the TEEs of the TSBs and be communicated over protected channels.
8. Confidentiality of metadata items. Confidentiality of some metadata items (e.g., secret and/or private keys) may be enforced and encrypted by the TEEs of the TSBs. Other metadata items (e.g., Uniform Resource Locators (URLs) and/or Uniform Resource Identifiers (URIs), or the like) may not have to be encrypted.

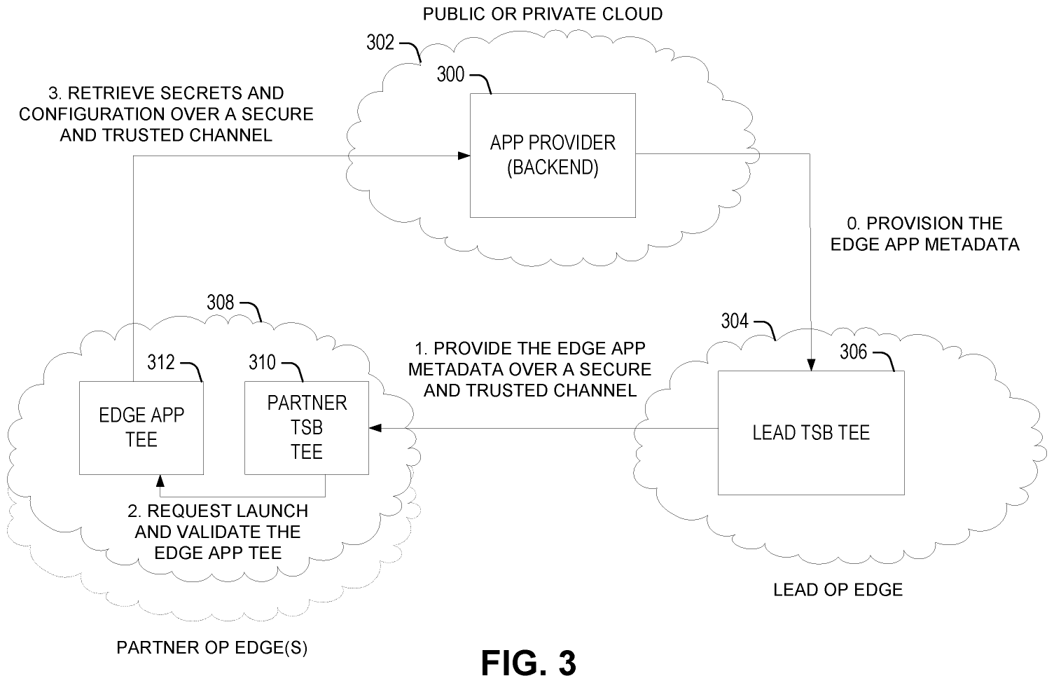

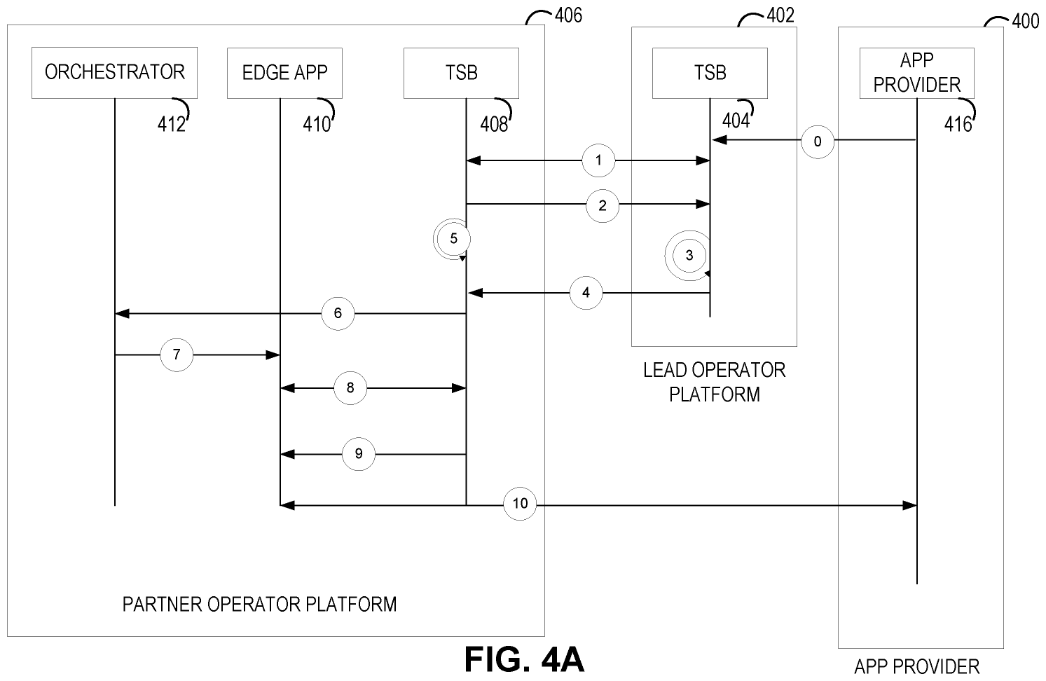

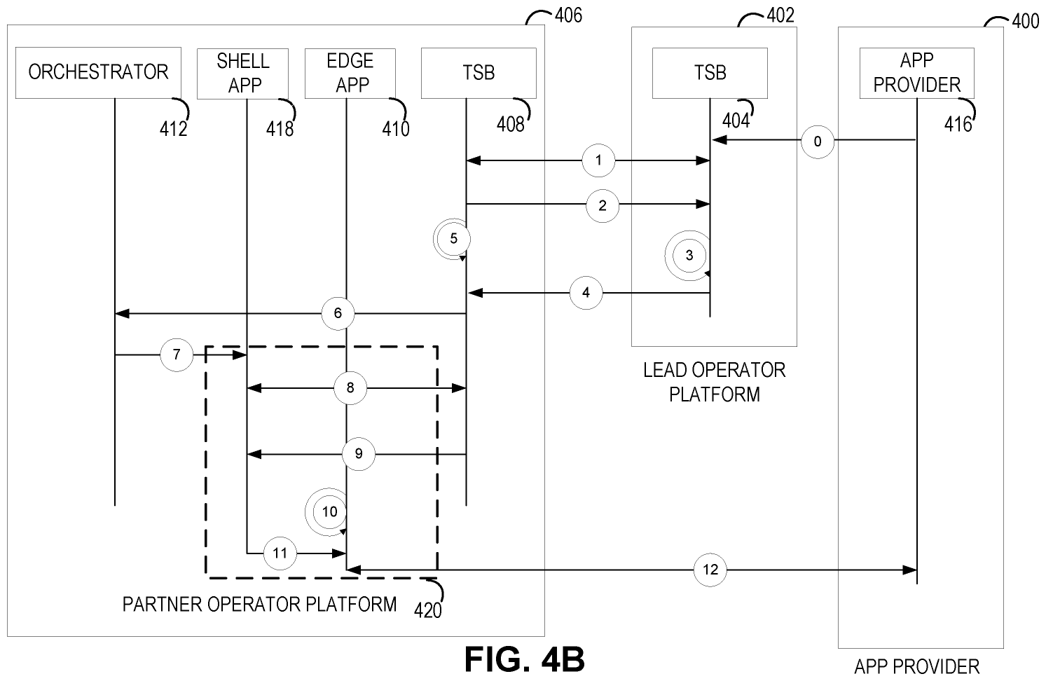

FIG. 3 illustrates example operations for launching an edge application in a secure environment of a partner operator platform. FIG. 3 illustrates the high-level flow of operations required to launch the edge application, and the details of the Operations will be described below for FIGS. 4A and 4B. As illustrated in FIG. 3, an Application Provider Backend 300 may be located in a public or private cloud 302. The lead trust status broker (TSB) Trusted Execution Environment (TEE) (Lead TSB TEE 306) may be located on a Lead Operator Platform Edge Cloud (Lead OP Edge 304). One or more Partner Operator Platform Edge Clouds (Partner OP Edge(s) 308) may contain a Partner TSB TEE 310 and an Edge App TEE 312. At Operation 0, the Application Provider Backend 300 may provision Edge App metadata, including confidential artifacts and provide the metadata or application information to the Lead TSB TEE 306. The Lead TSB TEE 306 thus may act as a proxy for the Application Provider Backend 300 and at Operation 1 provide the application information (including the metadata) to the Partner TSB TEE 310.

At Operation 2, the Partner TSB TEE 310 may transmit a request to the Edge App TEE 312. The request may include a request to launch the edge application and validation of the Edge App TEE 312. Then, once the edge application is launched, at Operation 3, the Edge App TEE 312 may retrieve secrets (e.g., encrypted keys and data) and configuration information and send the secrets and information to the Application Provider Backend 300 over a secure and trusted channel. The information provided by the Edge App TEE 312 to the Application Provider Backend 300 at Operation 3 may be used by the Application Provider Backend 300 to validate that the edge application was launched by a valid partner operator platform and/or identify the end user that launched the edge application.

In an example, the edge application may be launched in a hardware-based TEE that may isolate the edge application from other applications and from the infrastructure of the operator platform. The TSBs may also run in hardware-based TEEs that allow the app provider to provision or transmit its edge metadata, which may include confidential artifacts, into the lead operator platform TSB. Thus, the application provider may be confident that the TEE will isolate and protect the metadata from other tenants and from the lead operator platform TSB itself. The partner operator platform TSB may be trusted to initiate the launch of the edge application in its TEE, but also trusted to handle the edge application metadata and the edge application TEE attestation verification. Thus, the role of the TSBs is to establish trust and provide security. As discussed below for FIGS. 4A and 4B, other infrastructure on the partner operator platform, such as an orchestrator) may be relied upon to launch the edge application in the TEE on the appropriate physical edge node.

FIG. 4A illustrates an example flow diagram for trusted deployment of an edge application on a trusted operator platform. FIG. 4A includes an application provider 416 operating on an application provider secure environment 400, such as a trusted execution environment (TEE) and a lead operator platform secure environment 402, including a lead operator platform Trust Status Broker (lead operator platform TSB 404. FIG. 4A also shows a partner operator platform secure environment 406, which may include a partner operator platform TSB 408, and an orchestrator 412 to launch edge application 410 in the partner operator platform secure environment 406. The lead operator platform secure environment 402 may be architecture of or included in a user device, such as a computer system of a vehicle, a smartphone, or the like. The partner operator platform secure environment 406 may be included on a second device such as a computing node or other similar device on which the edge application 410 may be deployed on or migrated to. In an example, the lead operator platform secure environment 402 and/or the partner operator platform secure environment 406 may also be TEEs of the same or different type as the application provider secure environment 400.

In the flow of FIG. 4A, at Operation 0, application metadata or information may be provisioned, sent, or transmitted from the application provider 416 to the lead operator platform TSB 404. The application information may include one or more of: an address (e.g., a URI or URL) from where to download binaries for the edge application, binary signatures, TEE requirements for execution of the edge application 410, an application provider address (e.g., a URI or URL) that the edge application 410 may use to retrieve configuration information and encrypted data, and/or a signing key or certificate to generate authentication credentials for the edge application 410 to authenticate itself to the application provider 416 (e.g., to the Application Provider Backend 300 illustrated in FIG. 3).

At Operation 1, the lead operator platform secure environment 402 and the partner operator platform secure environment 406 may establish a mutually authenticated channel (a secure communication channel) between the lead operator platform TSB 404 and the partner operator platform TSB 408. The lead operator platform secure environment 402 may select the partner operator platform secure environment 406 to deploy or launch the application based on a trust level or a degree of trust determined from the application information (e.g., the TEE requirements for execution of the application). The mutual authentication may include a two factor authentication. The two factor authentication may include cross-TEE authentication. The cross-TEE authentication may include the lead operator platform TSB 404 and the partner operator platform TSB 408 verifying TEE attestation reports of each other. Restated, the lead operator platform TSB 404 may generate a first attestation report attesting to and verifying the credentials of the lead operator platform secure environment 402 and/or the lead operator platform TSB 404 and transmit the first attestation report to the partner operator platform TSB 408. Similarly, the partner operator platform TSB 408 may generate a second attestation report attesting to and verifying the credentials of the partner operator platform secure environment 406 and/or the partner operator platform TSB 408 and transmit the second attestation report to the lead operator platform TSB 404. Thus, the lead operator platform TSB 404 may use the second attestation report to verify that the partner operator platform secure environment 406 is a platform trusted to deploy the edge application 410.

The two factor authentication may also include the lead operator platform secure environment 402 and the partner operator platform secure environment 406 presenting one or more institutional credentials such as a certificate or mTLS credentials.

In an example, when multiple applications from multiple lead operator platforms are involved, an end user connected to the application provider secure environment 400 and the lead operator platform secure environment 402 may be provided additional information. For example, which application or applications to deploy, which user to launch the edge application instance on behalf of, and from which lead operator platform to retrieve the edge application information or metadata.

At Operation 2, the partner operator platform secure environment 406 may transmit a request to the lead operator platform secure environment 402. The request may include a request for one or more unique identifiers. For example, the partner operator platform secure environment 406 may request a unique identifier of the edge application, which may be included in the application information sent from the application provider 416 to the lead operator platform TSB 404 in Operation 0. Additionally, the partner operator platform secure environment 406 may request a unique identifier of the end user on behalf of whom the edge application is to launch.

In response to the request made in Operation 2, at Operation 3, the lead operator platform TSB 404 may generate a one-time credential (“Credential A”). Credential A may be used by the edge application 410 to identify the end user on behalf of which the edge application 410 instance will be launched or started. Further, Credential A may be used to provide proof that the edge application 410 instance will be started by an authorized, trusted, and/or secure partner operator platform (e.g., partner operator platform secure environment 406). The lead operator platform TSB 404 may generate Credential A using a signing key stored in the metadata and provided to the lead operator platform TSB 404 by the application provider 416 in Operation 0.

Also in response to the request made in Operation 2, in Operation 4, the lead operator platform TSB 404 may send at least a portion of the application information, the unique identifier or identifiers requested in Operation 2, and Credential A to the partner operator platform TSB 408. The information and data sent in Operation 4 may be transmitted over the secure communication channel established in Operation 1. The information and data sent in Operation 4 may also include a subset of the metadata discussed above such as the URL or URI from where to download the binary or binaries of the edge application 410, one or more binary signatures, TEE requirements for execution of the edge application 410 and/or an address to be used by the edge application 410 to retrieve configuration data, or the like.

At Operation 5, the partner operator platform TSB 408 may validate the binary signature or signatures discussed above and generate a one-time credential (“Credential B”). Credential B may be used by the edge application 410 to identify and authenticate itself to the partner operator platform TSB 408. In an example, Credential B may include one or more of: a random number passed to the edge application 410 as a parameter, a random number included in the TEE attestation report, and/or a signing key. When a signing key is included, a private portion of the key may be retained or kept at the partner operator platform TSB 408 and a public portion may be passed to the edge application 410 (e.g., as a CONFIGID). Keeping a private portion of the signing key at the partner operator platform TSB 408 and passing a public portion to the edge application 410 may allow the edge application 410 and the partner operator platform TSB 408 to mutually authenticate each other.

At Operation 6, the partner operator platform TSB 408 may send, transmit, or communicate a request to the orchestrator 412 to start or launch the edge application 410. In the request, the partner operator platform TSB 408 may send a portion of the application information to the orchestrator 412. For example, the partner operator platform TSB 408 may send one or more of: the addresses from the metadata from where to download the binary or binaries, the TEE requirements for running the edge application 410 from the metadata, Credential B, and/or signatures of the binaries (when the orchestrator 412 participates in the binary verification) to the edge application 410.

At Operation 7, the orchestrator 412 may launch the edge application 410 (or cause the edge application 410 to be launched) in the lead operator platform secure environment 402. In this Operation, the orchestrator 412 may provide Credential B to the edge application 410. At Operation 8, the edge application 410 may establish a trusted and secure channel with the partner operator platform TSB 408. In Operation 8, the edge application 410 may transmit an Edge App TEE attestation report to the partner operator platform TSB 408. The edge application 410 may also transmit Credential B, generated in Operation 5 and received by the edge application 410 in Operation 7 to the partner operator platform TSB 408. In an example, the edge application 410 may transmit Credential B to the partner operator platform TSB 408 in, with, at the same time (or substantially the same time), etc., as the Edge App TEE attestation report. Alternatively, the edge application 410 may transmit Credential B to the partner operator platform TSB 408 separately from the Edge App TEE attestation report.

In response to receiving Credential B from the edge application 410, the partner operator platform TSB 408 may use Credential B to uniquely identify the edge application instance and verify the edge application instance was launched on behalf of the partner operator platform TSB 408. The partner operator platform TSB 408 may verify the edge application instance using a CONFIGID or the like. This may provide a strong assurance and verification that the partner operator platform secure environment 406 is a trusted environment on which the edge application 410 may launch.

At Operation 9, the partner operator platform TSB 408 may send or transmit at least a portion of the application information, such as the metadata discussed above, to the edge application 410. For example, the partner operator platform TSB 408 may provide the URI or URL and Credential A that the partner operator platform TSB 408 received from the lead operator platform TSB 404 in Operation 3 to the edge application 410.

At Operation 10, the edge application 410 may use the URI or URL information (or similar address information) to connect to the application provider 416. The edge application 410 may send the application provider 416 the Edge App TEE attestation report discussed above (or generate and send a new report) and/or provide Credential A, which it received in Operation 9. Credential A may be included in the Edge App TEE attestation report or may be generated separately from the report and transmitted at the same time (or substantially the same time) as the Edge App TEE attestation report or transmitted separately from the report.

FIG. 4B illustrates an example flow diagram for trusted deployment of an edge application on a trusted operator platform including a hardware-based Trusted Execution Environment (TEE). Specifically, FIG. 4B adds additional architecture such as a shell application 418 and the dynamic hardware-based TEE 420 to the partner operator platform secure environment 406, which may modify at least some of the Operations discussed above in FIG. 4A.

In an example, Operations 0-3 may be the same, and performed in the same way as discussed in FIG. 4A. Operation 4 may include the details discussed above in FIG. 4A, with the addition that the metadata sent to the partner operator platform TSB 408 may further include a decryption key for the edge application 410 binaries, a URL or URI or other address from where to download a binary or binaries of the shell application 418, and one or more signatures of the shell application 418.

Operation 5 may include the details discussed for FIG. 4A and includes validating the binary signatures for the shell application 418, and while the partner operator platform TSB 408 may generate Credential B at this Operation, Credential B may be generated for the shell application 418 instead of the edge application 410. Restated, Credential B may be generated so that the shell application 418 may identify and authenticate itself to the partner operator platform TSB 408.

At Operation 6, the partner operator platform TSB 408 may transmit the URI or URL for the shell application 418 binaries from Operation 4 and Credential B generated for the shell application 418 in Operation 5 to the orchestrator 412. At Operation 7, the orchestrator 412 may provide Credential B to the shell application 418 in the dynamic hardware-based TEE 420.

At Operation 8, a secure and trusted channel may be established between the shell application 418 and the partner operator platform TSB 408. In this Operation, the shell application 418 may generate a Shell App TEE attestation report and send the attestation report, and Credential B to the partner operator platform TSB 408. Credential B may be included in the Shell App TEE attestation report or may be transmitted to the partner operator platform TSB 408 at the same time (or substantially the same time) or separately from the Shell App TEE attestation report. Upon receiving Credential B from the shell application 418, the partner operator platform TSB 408 may uniquely identify the shell application 418 instance and verify that the shell application 418 instance was launched on behalf of the partner operator platform TSB 408.

At Operation 9, the partner operator platform TSB 408 may send the metadata for the edge application 410 to the shell application 418. The metadata may include the URL or URI for the application provider 416, Credential A, the URL or URI for the edge application 410 binaries and the decryption key generated in Operation 4.

At Operation 10, the shell application 418 may decrypt the edge application 410 binaries in the dynamic hardware-based TEE 420. This Operation may include retrieving any encrypted edge application 410 binaries that are not locally cached. At Operation 11, the shell application 418 may launch the edge application 410 (or cause the edge application 410 to be launched) in the dynamic hardware-based TEE 420. During Operation 11, the shell application 418 may provide or transmit to the edge application 410 the URL or URI for the application provider 416 and Credential A.

At Operation 12, the edge application 410 may use the URI or URL information (or similar address information) to connect to the application provider 416. The edge application 410 may send the application provider 416 the Edge App TEE attestation report discussed above in FIG. 4A, (or generate and send a new report) and/or provide Credential A, which it received in Operation 11 from the shell application 418. Credential A may be included in the Edge App TEE attestation report or may be generated separately from the report and transmitted at the same time (or substantially the same time) as the Edge App TEE attestation report or may be transmitted separately from the report.

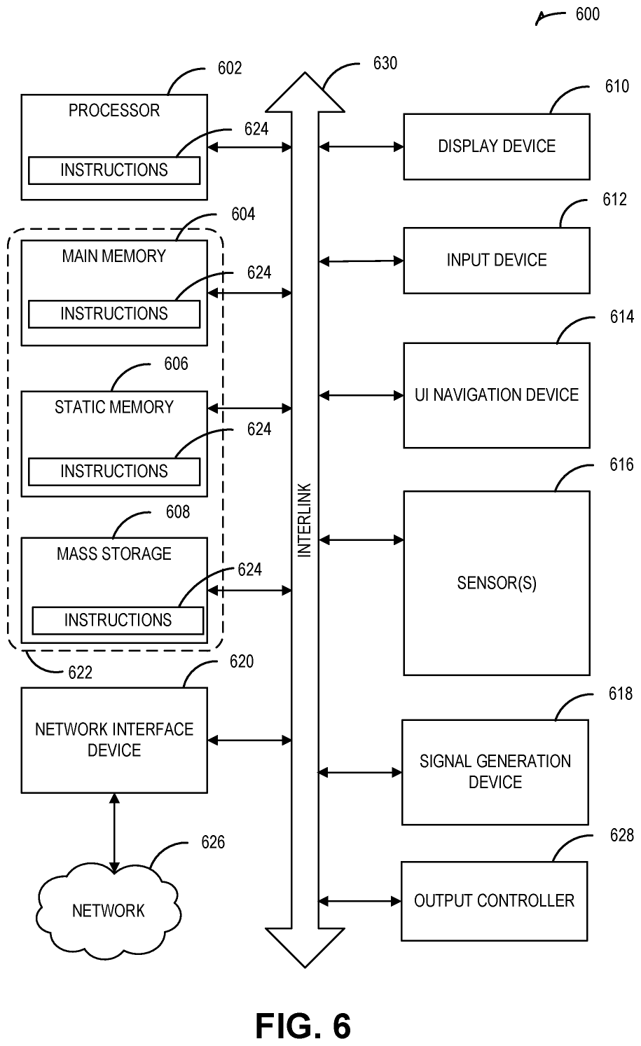

It is understood that the different secure environments or TEEs discussed above for FIGS. 4A and 4B may be different types of secure environments and/or different types of TEEs. Furthermore, the Operations discussed in FIGS. 4A and 4B are exemplary, and a method or an algorithm executing the Operations may omit one or more of the listed Operations, may repeat Operations, may include other Operations, or may execute the Operations concurrently, substantially simultaneously, or in another order, as appropriate or desired. Additionally, the Operations may be performed automatically by the processor or controller of a machine or computer, such as described below for FIG. 6.

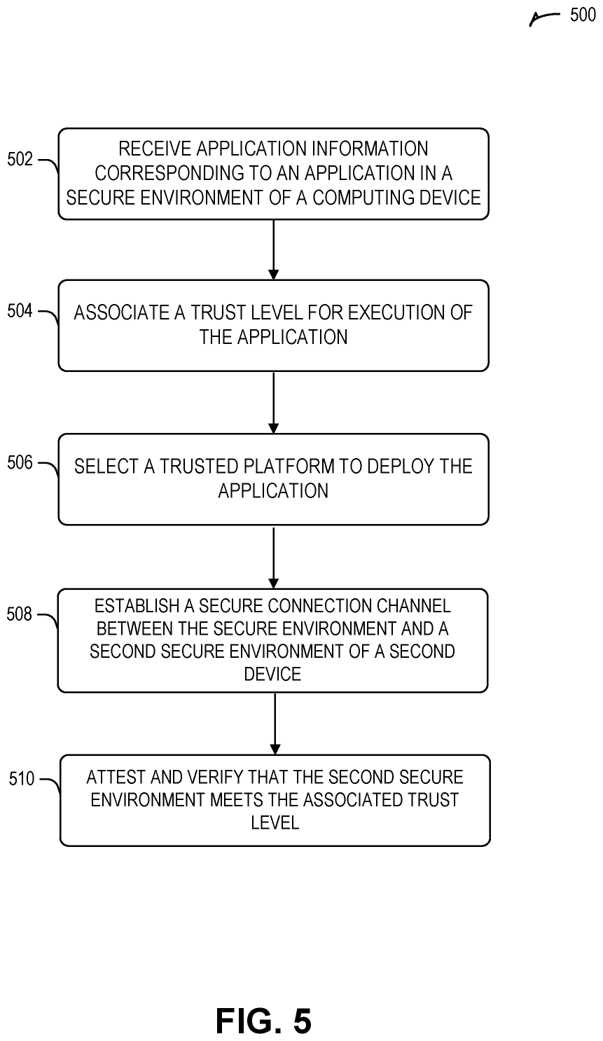

FIG. 5 illustrates an example method 500 for launching an edge application in a secure environment of a partner operator platform. The method 500 can include or comprise a number of Operations or Steps (502-510). These Operations are exemplary, and the method can omit one or more of the listed Operations, can repeat Operations, can include other Operations, or can execute the Operations concurrently, substantially simultaneously, or in another order, as appropriate or desired. The operations can be performed automatically by the processor or controller of a machine or computer, such as described below for FIG. 6.

At Operation 502, the method 500 may include receiving application information corresponding to an application in a secure environment of a computing device. The application information may be received from an application provider. The secure environment may act as a proxy for the application provider in deployment of the application information and resources. The application information may include one or more of: a uniform resource locator (URL) or a uniform resource identifier (URI), a binary signature of the application, a security requirement for execution of the application, or a signing key or certificate to generate authentication credentials for the application.

At Operation 504, the method 500 may include associating a trust level for execution of the application. The trust level may be determined at least in part from the application information. For example, the trust level can be determined from a security requirement e.g., a requirement for a Trusted Execution Environment (TEE) for execution of the application. In another example, portions of the application information may be correlated to determine the trust level to be associated. For example the trust level may be determined based on a security requirement and a geographic requirement correlated with a current location of a user.

At Operation 506, the method 500 may include selecting a trusted platform to deploy the application. The selection of the trusted platform may be based at least in part, on the associated trust level. At Operation 508, the method 500 may include establishing a secure connection channel between the secure environment and a second secure environment of a second device.

At Operation 510, the method 500 may include attesting and verifying that the second secure environment meets the associated trust level and is operating on the trusted platform. To attest and verify that the second secure environment meets the associated trust level and is operating on the trusted platform may include causing an attestation report to be sent from the secure environment to the second secure environment. The attestation report may include at least a credential of the secure environment. To attest and verify that the second secure environment meets the associated trust level and is operating on the trusted platform may also include causing a second attestation report to be sent from the second secure environment to the secure environment. The second attestation report may include at least a credential of the second secure environment.

Thus, the secure environment of the first device and the second secure environment of the second device mutually verify the other's credentials. When the secure environment, acting as the proxy for the application provider, confirms that the second device is trusted to launch the application and is capable of meeting any security requirements, QoS requirements, or the like, to launch and run the application, the application information may be passed or transmitted to the second secure environment. When the secure environment of the first device cannot verify that the second device is trusted to run the application and/or is not capable of meeting any security or QoS requirements, a different device may be selected to launch the application.

FIG. 6 is a block diagram of an example of a machine 600 upon which any one or more of the techniques (e.g., methodologies) discussed herein can perform.

The machine Error! Reference source not found.00 may operate as a standalone device or may be connected (e.g., networked) to other machines. For example, the machine 600 may be a component or a collection of components on one or more Internet of Things (IoT) devices, or a system to execute the Operations discussed in FIGS. 4A and 4B. Additionally, or alternatively, the machine may include one or more of the secure environments or TEEs discussed above.

In a networked deployment, the machine Error! Reference source not found.00 may operate in the capacity of a server machine, a client machine, or both in server-client network environments. In an example, the machine Error! Reference source not found.00 may act as a peer machine in peer-to-peer (P2P) (or other distributed) network environment. The machine Error! Reference source not found.00 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine Error! Reference source not found.00 (e.g., a computer system) may include a hardware processor Error! Reference source not found.02 (e.g., a central processing unit (CPU), a graphics processing unit (GPU), a hardware processor core, field programmable gate array (FPGA), or any combination thereof), a main memory Error! Reference source not found.04 and a static memory Error! Reference source not found.06, some or all of which may communicate with each other via an interlink (e.g., bus) Error! Reference source not found.30. The machine Error! Reference source not found.00 may further include a display unit Error! Reference source not found.10, an alphanumeric input device Error! Reference source not found.12 (e.g., a keyboard), and a user interface (UI) navigation device Error! Reference source not found.14 (e.g., a mouse). In an example, the display unit Error! Reference source not found.10, input device Error! Reference source not found.12 and UI navigation device Error! Reference source not found.14 may be a touch screen display. The machine Error! Reference source not found.00 may additionally include a storage device Error! Reference source not found.08 (e.g., a drive unit), a signal generation device Error! Reference source not found.18 (e.g., a speaker), a network interface device Error! Reference source not found.20, and one or more sensors Error! Reference source not found.16, such as a global positioning system (GPS) sensor, compass, accelerometer, or other sensor. The machine Error! Reference source not found.00 may include an output controller Error! Reference source not found.28, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device Error! Reference source not found.08 may include a machine readable medium Error! Reference source not found.22 on which is stored one or more sets of data structures or instructions Error! Reference source not found.24 (e.g., software) embodying or used by any one or more of the techniques or functions described herein. The instructions Error! Reference source not found.24 may also reside, completely or at least partially, within the main memory Error! Reference source not found.04, within static memory Error! Reference source not found.06, or within the hardware processor Error! Reference source not found.02 during execution thereof by the machine Error! Reference source not found.00. In an example, one or any combination of the hardware processor Error! Reference source not found.02, the main memory Error! Reference source not found.04, the static memory Error! Reference source not found.06, or the storage device Error! Reference source not found.08 may constitute machine readable media.

While the machine readable medium Error! Reference source not found.22 is illustrated as a single medium, the term “machine readable medium” may include a single medium or multiple media (e.g., a centralized or distributed database, and/or associated caches and servers) configured to store the one or more instructions Error! Reference source not found.24.

The term “machine readable medium” may include any non-transitory medium that is capable of storing, encoding, or carrying instructions for execution by the machine Error! Reference source not found.00 and that cause the machine Error! Reference source not found.00 to perform any one or more of the techniques of the present disclosure, or that is capable of storing, encoding, or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions Error! Reference source not found.24 may further be transmitted or received over a communications network Error! Reference source not found.26 using a transmission medium via the network interface device Error! Reference source not found.20 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards), IEEE 802.15.4 family of standards, peer-to-peer (P2P) networks, among others. In an example, the network interface device Error! Reference source not found.20 may include one or more physical jacks (e.g., Ethernet, coaxial, or phone jacks) or one or more antennas to connect to the communications network Error! Reference source not found.26. In an example, the network interface device Error! Reference source not found.20 may include a plurality of antennas to wirelessly communicate using at least one of single-input multiple-output (SIMO), multiple-input multiple-output (MIMO), or multiple-input single-output (MISO) techniques.

The term “transmission medium” shall be taken to include any intangible medium that is capable of storing, encoding, or carrying instructions for execution by the machine Error! Reference source not found.00, and includes digital or analog communications signals or other intangible medium to facilitate communication of such software.

### ADDITIONAL NOTES & EXAMPLES

Example 1 is a non-transitory machine-readable medium with instructions stored thereon that, when executed by a processor of a device, cause the processor to: receive application information corresponding to an application from an application provider in a secure environment on an operator platform of the device; associate a trust level for execution of the application; and select a trusted federated operator platform to deploy the application based on the associated trust level.

In Example 2, the subject matter of Example 1 optionally includes wherein the secure environment of the device acts as a proxy for the application provider, wherein the associated trust level is based at least in part on the application information, and wherein the application information includes: a uniform resource locator (URL) or a uniform resource identifier (URI); a binary signature of the application; a security requirement for execution of the application; and a signing key or certificate to generate authentication credentials for the application.

In Example 3, the subject matter of Example 2 optionally includes wherein the instructions further cause the processor to: establish a secure communication channel between the secure environment and a second secure environment of a second device, the second device including the trusted federated operator platform; and attest and verify that the second secure environment meets the associated trust level and is operating on the trusted federated operator platform.

In Example 4, the subject matter of Example 3 optionally includes wherein to attest and verify that the second secure environment meets the associated trust level and is operating on the trusted federated operator platform includes: causing a first attestation report to be sent from the secure environment to the second secure environment, the first attestation report including a credential of the secure environment; and causing a second attestation report to be sent from the second secure environment to the secure environment, the second attestation report including a credential of the second secure environment.

In Example 5, the subject matter of any one or more of Examples 3-4 optionally include wherein the instructions further cause the processor to: receive a request from the second secure environment via the secure communication channel, the request including a request for a unique identifier; and in response to receipt of the request from the second secure environment: generate a first one-time credential from the application information received from the application provider; and send, via the secure communication channel, at least a portion of the application information, the unique identifier, and the first one-time credential to the second secure environment to allow the second device to launch the application.

In Example 6, the subject matter of Example 5 optionally includes wherein the instructions further cause the processor to: cause the second secure environment to validate the binary signature; generate a second one-time credential to be used by the application; and request an orchestrator to launch the application, wherein the request includes providing the orchestrator with the URL or URI, the security requirement, and the generated second one-time credential.

In Example 7, the subject matter of Example 6 optionally includes wherein the instructions further cause the processor to: cause the orchestrator to launch the application; provide the application with the URL or URI, the security requirement, the first one-time credential, and the second one-time credential; use the second one-time credential to uniquely identify the launched application; and use the second one-time credential to verify the launched application is launched on behalf of the second secure environment.

In Example 8, the subject matter of Example 7 optionally includes wherein the instructions further cause the processor to: cause the application to connect to the application provider using the URL or the URI; cause the application to generate an application attestation report, verifying that the application is running in a valid secure environment; and cause the application to send the application attestation report, the first one-time credential, and the second one-time credential to the application provider.

In Example 9, the subject matter of any one or more of Examples 5-8 optionally include wherein the instructions further cause the processor to: cause the second secure environment to send the at least a portion of the application information to a shell application in a hardware-based Trusted Execution Environment (TEE) on the second device.

In Example 10, the subject matter of Example 9 optionally includes wherein the secure environment operates within a first Trusted Execution Environment (TEE), wherein the second secure environment operates within a second TEE, and wherein the at least a portion of the application information includes the binary signature, wherein the binary signature is encrypted, and wherein the binary signature is decrypted by the shell application in the hardware-based TEE.

Example 11 is a computing node, comprising: trusted execution circuitry on an operator platform of the computing node; and processing circuitry to cause a secure environment of the computing node to: receive application information corresponding to an application from an application provider in the secure environment of the computing node; associate a trust level for execution of the application; and select a trusted federated operator platform to deploy the application based on the associated trust level.

In Example 12, the subject matter of Example 11 optionally includes wherein the processing circuitry further causes the secure environment to: establish a communication channel between the secure environment and a second secure environment of a second computing node, the second computing node including the trusted federated operator platform; receive a request from the second secure environment of the second computing node, the request including a request for a unique identifier via the communication channel; and in response to receiving the request from the second computing node: generate a first credential from the application information received from the application provider; and send, via the communication channel, at least a portion of the application information, the unique identifier, and the first credential to the second secure environment of the second computing node to allow the second computing node to launch the application.

In Example 13, the subject matter of Example 12 optionally includes wherein the processing circuitry further causes the secure environment to: send an attestation report to the secure environment to the second secure environment, the attestation report including a credential of the secure environment.

In Example 14, the subject matter of any one or more of Examples 11-13 optionally include wherein the application information includes: a uniform resource locator (URL) or a uniform resource identifier (URI); a binary signature of the application; a security requirement for execution of the application; and a signing key or certificate to generate authentication credentials for the application.

Example 15 is a computing node, comprising: trusted execution circuitry on a federated operator platform of the computing node; and processing circuitry to cause a secure environment of the computing node to: authenticate a communication channel between the secure environment of the computing node and a second secure environment located on a second computing node of a second federated operator platform; transmit a request for a unique identifier via the communication channel to the second secure environment; receive application information for an application from the second secure environment, the application information including the unique identifier; prepare to launch the application, wherein to prepare to launch the application includes generating a one-time credential to authenticate the application at the secure environment; and launch the application using the received application information and the generated one-time credential.

In Example 16, the subject matter of Example 15 optionally includes wherein the application information includes: a uniform resource locator (URL) or a uniform resource identifier (URI); a binary signature of the application; a security requirement for execution of the application; and a signing key or certificate to generate authentication credentials for the application.

In Example 17, the subject matter of Example 16 optionally includes wherein the processing circuitry further causes the secure environment of the computing node to: establish a secure channel with the launched application; and transmit at least a portion of the application information to the launched application to allow the launched application to communicate with an application provider and confirm to the application provider that computing device is a trusted device.

In Example 18, the subject matter of Example 17 optionally includes additional processing circuitry to provide an orchestrator, wherein the secure environment causes the orchestrator to launch the application, and wherein to cause the orchestrator to launch the application includes providing the orchestrator with the one-time credential.

In Example 19, the subject matter of any one or more of Examples 16-18 optionally include additional circuitry to establish a hardware-based Trusted Execution Environment (TEE).

In Example 20, the subject matter of Example 19 optionally includes wherein the at least a portion of the application information includes the binary signature, wherein the binary signature is encrypted, and wherein the binary signature is decrypted by a shell application in the hardware-based TEE.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A non-transitory machine-readable medium with instructions stored thereon that, when executed by a processor of a device, cause the processor to:
receive application information corresponding to an application from an application provider in a secure environment on an operator platform of the device;
associate a trust level for execution of the application; and
select a trusted federated operator platform to deploy the application based on the associated trust level.

2. The non-transitory machine-readable medium of claim 1, wherein the secure environment of the device acts as a proxy for the application provider, wherein the associated trust level is based at least in part on the application information, and wherein the application information includes:
a uniform resource locator (URL) or a uniform resource identifier (URI);
a binary signature of the application;
a security requirement for execution of the application; and
a signing key or certificate to generate authentication credentials for the application.

3. The non-transitory machine-readable medium of claim 2, wherein the instructions further cause the processor to:
establish a secure communication channel between the secure environment and a second secure environment of a second device, the second device including the trusted federated operator platform; and
attest and verify that the second secure environment meets the associated trust level and is operating on the trusted federated operator platform.

4. The non-transitory machine-readable medium of claim 3, wherein to attest and verify that the second secure environment meets the associated trust level and is operating on the trusted federated operator platform includes:
causing a first attestation report to be sent from the secure environment to the second secure environment, the first attestation report including a credential of the secure environment; and
causing a second attestation report to be sent from the second secure environment to the secure environment, the second attestation report including a credential of the second secure environment.

5. The non-transitory machine-readable medium of claim 3, wherein the instructions further cause the processor to:
receive a request from the second secure environment via the secure communication channel, the request including a request for a unique identifier; and
in response to receipt of the request from the second secure environment:
generate a first one-time credential from the application information received from the application provider; and
send, via the secure communication channel, at least a portion of the application information, the unique identifier, and the first one-time credential to the second secure environment to allow the second device to launch the application.

6. The non-transitory machine-readable medium of claim 5, wherein the instructions further cause the processor to:
cause the second secure environment to validate the binary signature;
generate a second one-time credential to be used by the application; and
request an orchestrator to launch the application, wherein the request includes providing the orchestrator with the URL or URI, the security requirement, and the generated second one-time credential.

7. The non-transitory machine-readable medium of claim 6, wherein the instructions further cause the processor to:
cause the orchestrator to launch the application;
provide the application with the URL or URI, the security requirement, the first one-time credential, and the second one-time credential;
use the second one-time credential to uniquely identify the launched application; and
use the second one-time credential to verify the launched application is launched on behalf of the second secure environment.

8. The non-transitory machine-readable medium of claim 7, wherein the instructions further cause the processor to:
cause the application to connect to the application provider using the URL or the URI;
cause the application to generate an application attestation report, verifying that the application is running in a valid secure environment; and
cause the application to send the application attestation report, the first one-time credential, and the second one-time credential to the application provider.

9. The non-transitory machine-readable medium of claim 5, wherein the instructions further cause the processor to:
cause the second secure environment to send the at least a portion of the application information to a shell application in a hardware-based Trusted Execution Environment (TEE) on the second device.

10. The non-transitory machine-readable medium of claim 9, wherein the secure environment operates within a first Trusted Execution Environment (TEE), wherein the second secure environment operates within a second TEE, and wherein the at least a portion of the application information includes the binary signature, wherein the binary signature is encrypted, and wherein the binary signature is decrypted by the shell application in the hardware-based TEE.

11. A computing node, comprising:
trusted execution circuitry on an operator platform of the computing node; and
processing circuitry to cause a secure environment of the computing node to:
receive application information corresponding to an application from an application provider in the secure environment of the computing node;
associate a trust level for execution of the application; and
select a trusted federated operator platform to deploy the application based on the associated trust level.

12. The computing node of claim 11, wherein the processing circuitry further causes the secure environment to:
establish a communication channel between the secure environment and a second secure environment of a second computing node, the second computing node including the trusted federated operator platform;
receive a request from the second secure environment of the second computing node, the request including a request for a unique identifier via the communication channel; and
in response to receiving the request from the second computing node:
generate a first credential from the application information received from the application provider; and
send, via the communication channel, at least a portion of the application information, the unique identifier, and the first credential to the second secure environment of the second computing node to allow the second computing node to launch the application.

13. The computing node of claim 12, wherein the processing circuitry further causes the secure environment to:
send an attestation report to the secure environment to the second secure environment, the attestation report including a credential of the secure environment.

14. The computing node of claim 11, wherein the application information includes:
a uniform resource locator (URL) or a uniform resource identifier (URI);
a binary signature of the application;
a security requirement for execution of the application; and
a signing key or certificate to generate authentication credentials for the application.

15. A computing node, comprising:
trusted execution circuitry on a federated operator platform of the computing node; and
processing circuitry to cause a secure environment of the computing node to:
authenticate a communication channel between the secure environment of the computing node and a second secure environment located on a second computing node of a second federated operator platform;
transmit a request for a unique identifier via the communication channel to the second secure environment;
receive application information for an application from the second secure environment, the application information including the unique identifier;
prepare to launch the application, wherein to prepare to launch the application includes generating a one-time credential to authenticate the application at the secure environment; and
launch the application using the received application information and the generated one-time credential.

16. The computing node of claim 15, wherein the application information includes:
a uniform resource locator (URL) or a uniform resource identifier (URI);
a binary signature of the application;
a security requirement for execution of the application; and
a signing key or certificate to generate authentication credentials for the application.

17. The computing node of claim 16, wherein the processing circuitry further causes the secure environment of the computing node to:
establish a secure channel with the launched application; and
transmit at least a portion of the application information to the launched application to allow the launched application to communicate with an application provider and confirm to the application provider that computing device is a trusted device.

18. The computing node of claim 17, further comprising:
additional processing circuitry to provide an orchestrator, wherein the secure environment causes the orchestrator to launch the application, and wherein to cause the orchestrator to launch the application includes providing the orchestrator with the one-time credential.

19. The computing node of claim 16, further comprising:
additional circuitry to establish a hardware-based Trusted Execution Environment (TEE).

20. The computing node of claim 19, wherein the at least a portion of the application information includes the binary signature, wherein the binary signature is encrypted, and wherein the binary signature is decrypted by a shell application in the hardware-based TEE.
